SEQUENCE LISTING (11 sequences)

SEQ ID NO: 1 - protein, 571 aa, Artificial Sequence
  Recombinant gelatin
GAPGAPGLQGAPGLQGMPGERGAAGLPGPKGERGDAGPKGADGAPGAPGLQGMPGERGAAGLPGPKGERGDAGPKGADGAPGKDGVRGLAGPIGPPGERGAAGLPGPKGERGDAGPKGADGAPGKDGVRGLAGPIGPPGPAGAPGAPGLQGMPGERGAAGLPGPKGERGDAGPKGADGAPGKDGVRGLAGPPGAPGLQGAPGLQGMPGERGAAGLPGPKGERGDAGPKGADGAPGAPGLQGMPGERGAAGLPGPKGERGDAGPKGADGAPGKDGVRGLAGPIGPPGERGAAGLPGPKGERGDAGPKGADGAPGKDGVRGLAGPIGPPGPAGAPGAPGLQGMPGERGAAGLPGPKGERGDAGPKGADGAPGKDGVRGLAGPPGAPGLQGAPGLQGMPGERGAAGLPGPKGERGDAGPKGADGAPGAPGLQGMPGERGAAGLPGPKGERGDAGPKGADGAPGKDGVRGLAGPIGPPGERGAAGLPGPKGERGDAGPKGADGAPGKDGVRGLAGPIGPPGPAGAPGAPGLQGMPGERGAAGLPGPKGERGDAGPKGADGAPGKDGVRGLAGPPG

SEQ ID NO: 2 - protein, 4 aa, Artificial Sequence
  Description of Artificial Sequence adhesive sequence
REDV

SEQ ID NO: 3 - protein, 5 aa, Artificial Sequence
  Description of Artificial Sequence adhesive sequence
YIGSR

SEQ ID NO: 4 - protein, 5 aa, Artificial Sequence
  Description of Artificial Sequence adhesive sequence
PDSGR

SEQ ID NO: 5 - protein, 7 aa, Artificial Sequence
  Description of Artificial Sequence adhesive sequence
RYVVLPR

SEQ ID NO: 6 - protein, 6 aa, Artificial Sequence
  Description of Artificial Sequence adhesive sequence
LGTIPG

SEQ ID NO: 7 - protein, 10 aa, Artificial Sequence
  Description of Artificial Sequence adhesive sequence
RNIAEIIKDI

SEQ ID NO: 8 - protein, 5 aa, Artificial Sequence
  Description of Artificial Sequence adhesive sequence
IKVAV

SEQ ID NO: 9 - protein, 4 aa, Artificial Sequence
  Description of Artificial Sequence adhesive sequence
DGEA

SEQ ID NO: 10 - protein, 4 aa, Artificial Sequence
  Description of Artificial Sequence adhesive sequence
ERGD

SEQ ID NO: 11 - protein, 571 aa, Artificial Sequence
  CBE
  MISC_FEATURE (1)..(571): all Xaa is independently any amino acid
GAPGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXGXXG

(19) United States
(12) Patent Application Publication
(10) Pub. No.: US 2020/0015475 A1
(43) Pub. Date: Jan. 16, 2020

(54) CELL MASS OR CELL STRUCTURE-EMBEDDING AGENT, CELL MASS OR CELL STRUCTURE-CONTAINING COMPOSITION, AND KIT

(71) Applicant: FUJIFILM Corporation, Tokyo (JP)

(72) Inventors: Kentaro Nakamura, Ashigarakami-gun (JP); Yasuhiro Yoshioka, Ashigarakami-gun (JP)

(73) Assignee: FUJIFILM Corporation, Tokyo (JP)

(21) Appl. No.: 16/556,645

(22) Filed: Aug. 30, 2019

Related U.S. Application Data
(63) Continuation of application No. PCT/JP2018/007943, filed on Mar. 2, 2018.

(30) Foreign Application Priority Data
Mar. 2, 2017 (JP) 2017-038938

(51) Int. Cl. A01N 1/02

(52) U.S. Cl. CPC A01N 1/0231; A01N 1/021

(57) ABSTRACT

The object of the present invention is to provide a cell mass or cell structure-embedding agent that can stably transport cell masses or cell structures in a case of transportation at a low temperature and after transportation, conveniently recover a cell mass or cell structure from the cell mass or cell structure-embedding agent, a cell mass or cell structure-containing composition, and a kit. According to the present invention, provided is a cell mass or cell structure-embedding agent including: polypeptide which is represented by Formula 1 and in which an area of the maximum molecular weight peak in molecular weight distribution measurement is 80% or more of the total area of all of the molecular weight peaks.

A-[(Gly-X-Y)ₙ]ₘ-B Formula (1):

In the formula, X's and Y's each independently represent an amino acid, m is an integer of 2 to 10, n is an integer of 3 to 100, and A and B represent any amino acids or amino acid sequences.

### CROSS-REFERENCE TO RELATED APPLICATIONS

This application is a Continuation of PCT International Application No. PCT/JP2018/007943 filed on Mar. 2, 2018, which claims priority under 35 U.S.C § 119(a) to Japanese Patent Application No. 2017-038938 filed on Mar. 2, 2017. Each of the above application(s) is hereby expressly incorporated by reference, in its entirety, into the present application.

### BACKGROUND OF THE INVENTION

### 1. Field of the Invention

The present invention relates to a cell mass or cell structure-embedding agent including polypeptide in which molecular weight distribution satisfies a predetermined condition. The present invention relates to a cell mass or cell structure-containing composition and a kit including the cell mass or cell structure-embedding agent.

### 2. Description of the Related Art

In recent years, many regenerative medicine and cell transplantation therapies have been implemented. Particularly, treatments using cells as cell masses or cell structures have been considered. Since the cell mass or cell structure is maintained as a structure as compared with administration of individual cells as a suspension, it is considered that engraftment in the body is satisfactory and more effective.

JP2004-357694A discloses a method of performing osteochondral regeneration by using cell masses of tissue-derived stem cells. WO2011/108517A discloses a cell structure including a macromolecular block having biocompatibility and cells, in which a plurality of the macromolecular blocks are arranged in gaps between the plurality of cells. In the cell structure disclosed in WO2011/108517A, nutrient from the outside to the inside of the cell structure can be delivered, the cell has a sufficient thickness, and cells are uniformly present in the structure. In the example of WO2011/108517A, high cell survival activity is demonstrated by using a macromolecular block formed of recombinant gelatin or a natural gelatin material. JP2005-35945A discloses a cell transplant cell structure including a macromolecular block having biocompatibility and at least one type of cells, in which a plurality of the macromolecular blocks are arranged in gaps between the plurality of cells. In the example of JP2005-35945A, angiogenesis was evaluated by using a cell transplantation cell structure.

Meanwhile, WO2008/103041A discloses genetically modified gelatin that is particularly useful in several uses involving cell attachment, for example, cell culture work, uses involving cell culture of anchorage-dependent cells, and various medical uses.

### SUMMARY OF THE INVENTION

There are problems in that cell masses or cell structures are very fragile and are easily broken during transportation, which causes problems in a case of being transported to hospital facilities or the like. In the hospital facilities or the like, it is desirable that cell masses or cell structures can be easily transplanted after transportation of the cell masses or cell structures. It is desirable to solve the above problems in the transplantation of cell masses or cell structures. An object of the present invention is to provide a cell mass or cell structure-embedding agent that can stably transport cell masses or cell structures in a case of transportation at a low temperature and after transportation, conveniently recover a cell mass or cell structure from the cell mass or cell structure-embedding agent. Another object of the present invention is to provide a cell mass or cell structure-containing composition including the cell mass or cell structure-embedding agent and a kit including the cell mass or cell structure-embedding agent.

The present inventors have diligently conducted research to achieve the above objects and found that, according to a cell mass or cell structure-embedding agent including polypeptide which has a specific sequence and in which an area of the maximum molecular weight peak in molecular weight distribution measurement is 80% or more of the total area of all of the molecular weight peaks, it is possible to stably transport cell masses or cell structures in a case of transportation at a low temperature and after transportation, and conveniently recover a cell mass or cell structure from the cell mass or cell structure-embedding agent at room temperature in a case of transplantation of a cell mass or a cell structure. The present invention has been completed based on the finding. According to the present invention, the following inventions are provided.

[1] A cell mass or cell structure-embedding agent comprising: polypeptide which is represented by Formula 1 and in which a molecular weight distribution satisfies Condition X,

A-[(Gly-X-Y)ₙ]ₘ-B Formula 1:

in the formula, n X's each independently represent any amino acid, n Y's each independently represent any amino acid, m is an integer of 2 to 10, n is an integer of 3 to 100, A represents any amino acid or amino acid sequence, and B represents any amino acid or amino acid sequence,

Condition X: An area of the maximum molecular weight peak in molecular weight distribution measurement by gel permeation chromatography is 80% or more of the total area of all of the molecular weight peaks.

[2] The cell mass or cell structure-embedding agent according to [1], in which the polypeptide is recombinant gelatin.
[3] The cell mass or cell structure-embedding agent according to [1] or [2], in which the polypeptide is polypeptide represented by Formula 2,

Gly-Ala-Pro-[(Gly-X-Y)₆₃]₃-Gly (SEQ ID NO: 11) Formula 2:

in the formula, 63 pieces of X (=Xaa) each independently represent any amino acid and 63 pieces of Y (=Xaa) each independently represent any amino acid, and 63 pieces of Gly-X-Y may be identical to or different from each other.

[4] The cell mass or cell structure-embedding agent according to any one of [1] to [3], in which the polypeptide has (1) an amino acid sequence presented in SEQ ID NO: 1 or (2) an amino acid sequence that has 80% or more of sequence identity with the amino acid sequence presented in SEQ ID NO: 1 and has biocompatibility.
[5] The cell mass or cell structure-embedding agent according to any one of [1] to [4], in which the polypeptide has an amino acid sequence presented in SEQ ID NO: 1.
[6] A cell mass or cell structure-containing composition comprising: a cell mass or cell structure; and the cell mass or cell structure-embedding agent according to any one of [1] to [5], in which the cell mass or the cell structure is embedded with the cell mass or cell structure-embedding agent.
[7] A kit comprising: a cell mass or cell structure; and the cell mass or cell structure-embedding agent according to any one of [1] to [5].
[8] Polypeptide which is to be used in embedding of a cell mass or cell structure and is represented by Formula 1 and in which a molecular weight distribution satisfies Condition X,

A-[(Gly-X-Y)ₙ]ₘ-B Formula 1:

in the formula, n X's each independently represent any one of amino acids, n Y's each independently represent any amino acids, m is an integer of 2 to 10, n is an integer of 3 to 100, A represents any amino acid or amino acid sequence, and B represents any amino acid or amino acid sequence,

Condition X: An area of the maximum molecular weight peak in molecular weight distribution measurement by gel permeation chromatography is 80% or more of the total area of all of the molecular weight peaks.

[9] A use of polypeptide which is to be used in manufacturing of a cell mass or cell structure-embedding agent and is represented by Formula 1 and in which a molecular weight distribution satisfies Condition X,

A-[(Gly-X-Y)ₙ]ₘ-B Formula 1:

in the formula, n X's each independently represent any one of amino acids, n Y's each independently represent any amino acids, m is an integer of 2 to 10, n is an integer of 3 to 100, A represents any amino acid or amino acid sequence, and B represents any amino acid or amino acid sequence,

Condition X: An area of the maximum molecular weight peak in molecular weight distribution measurement by gel permeation chromatography is 80% or more of the total area of all of the molecular weight peaks.

[10] A method of embedding a cell mass or cell structure, the method including: embedding a cell mass or cell structure with polypeptide which is represented by Formula 1 and in which a molecular weight distribution satisfies Condition X,

A-[(Gly-X-Y)ₙ]ₘ-B Formula 1:

in the formula, n X's each independently represent any one of amino acids, n Y's each independently represent any amino acids, m is an integer of 2 to 10, n is an integer of 3 to 100, A represents any amino acid or amino acid sequence, and B represents any amino acid or amino acid sequence,

Condition X: An area of the maximum molecular weight peak in molecular weight distribution measurement by gel permeation chromatography is 80% or more of the total area of all of the molecular weight peaks.

According to the cell mass or cell structure-embedding agent, the cell mass or cell structure-containing composition, and the kit according to the embodiment of the present invention, a cell mass or cell structure can be stably transported in a case of low temperature transportation, and after the transportation, a cell mass or a cell structure can be easily recovered from cell mass or cell structure-embedding agent.

### BRIEF DESCRIPTION OF THE DRAWINGS

FIG. 1 illustrates molecular weight distribution of recombinant gelatin.

FIG. 2 illustrates molecular weight distribution of natural animal gelatin.

FIG. 3 illustrates shapes of CBE3 embedded cell structures before and after shaking.

### DESCRIPTION OF THE PREFERRED EMBODIMENTS

Hereinafter, an embodiment of the present invention will be described in detail.

<Cell Mass or Cell Structure-Embedding Agent>

The cell mass or cell structure-embedding agent according to the embodiment of the present invention is a cell mass or cell structure-embedding agent including polypeptide which is represented by Formula 1 and in which molecular weight distribution satisfies Condition X.

A-[(Gly-X-Y)ₙ]ₘ-B Formula 1:

In the formula, n X's each independently represent any amino acids, n Y's each independently represent any amino acids, m is an integer of 2 to 10, n is an integer of 3 to 100, A represents any amino acid or amino acid sequence, and B represents any amino acid or amino acid sequence.

Condition X: An area of the maximum molecular weight peak in molecular weight distribution measurement by gel permeation chromatography is 80% or more of the total area of the all molecular weight peaks.

The cell mass or cell structure-embedding agent described in the present specification is a material that can perform an embedding treatment on a cell mass or a cell structure. The embedding treatment is a treatment of causing a portion or an entire portion of the surface of the cell mass or the cell structure to come into contact with the cell mass or cell structure-embedding agent by immersion or the like and covering the portion or the entire portion of the surface of the cell mass or the cell structure with the cell mass or cell structure-embedding agent.

[Polypeptide]

The polypeptide represented by Formula 1 is gelled by embedding cell masses or cell structures in a solution state (not a low temperature condition) and reducing the temperature, to be in a state that is suitable for transportation. In view of cell preservation, it is necessary to keep the temperature low during the transportation. In the present invention, polypeptide is sharply gelled at a low temperature (4° C.) and the dissolution at room temperature (25° C.) by satisfying Condition X (the area of the maximum molecular weight peak in the molecular weight distribution measurement by gel permeation chromatography is 80% or more of the total area of the all molecular weight peaks), and in a case of transplantation of a cell mass or a cell structure, a cell mass or a cell structure can be easily recovered from the cell mass or cell structure-embedding agent at room temperature.

As described above, in the present invention, the area of the maximum molecular weight peak in the molecular weight distribution measurement by the gel permeation chromatography is 80% or more, more preferably 85% or more, and particularly preferably 90% or more of the total area of the all molecular weight peaks.

The molecular weight distribution by gel permeation chromatography can be measured by using high performance liquid chromatography (HPLC) (AQUITY UPLC system Empower 2 manufactured by Waters Corporation) and using 100 mmol/L of a phosphate buffer (pH 6.8) as a buffer solution.

In Formula 1, m is an integer of 2 to 10 and preferably 3 to 5.

In Formula 1, n is an integer of 3 to 100, preferably an integer of 15 to 70, and more preferably an integer of 50 to 65.

The polypeptide represented by Formula 1 used in the present invention may be any of recombinant polypeptide, chemically synthesized polypeptide, or natural polypeptide, as long as the molecular weight distribution satisfies the above condition X.

Chemically synthesized polypeptide means artificially synthesized polypeptide. The synthesis of a polypeptide may be solid phase synthesis or liquid phase synthesis, but is preferably solid phase synthesis. The solid phase synthesis of a polypeptide is well-known to those skilled in the art, and examples thereof include a fluorenyl-methoxy-carbonyl group (Fmoc group) synthesis method in which a Fmoc group is used for protection of an amino group, and a tert-butyl oxy carbonyl group (Boc group) synthesis method in which a Boc group is used for protection of an amino group.

The polypeptide is preferably a recombinant polypeptide. In the present specification, recombinant polypeptide represented by Formula 1 is referred to as recombinant gelatin. The recombinant gelatin will be described below in the present specification.

A “1/IOB” value which is a hydrophilicity value of the polypeptide used in the present invention is preferably 0 to 1.0. The value is more preferably within a range of 0 to 0.6, and even more preferably within a range of 0 to 0.4. IOB is an index of hydrophilic and hydrophobic properties based on an organic conceptual diagram representing polarity and non-polarity of an organic compound proposed by Atsushi HUJITA, and the details thereof are described in, for example, “Pharmaceutical Bulletin”, vol. 2, 2, pp. 163 to 173 (1954), “Area of Chemistry” vol. 11, 10, pp. 719-725 (1957), and “Fragrance Journal, vol. 50, pp. 79 to 82 (1981). Briefly, the root of every organic compound is set to methane (CH₄), and all of other compounds are regarded as derivatives of methane. Certain numerical values for the number of carbons thereof, a substituent group, a transformation portion, a ring, and the like are set, and an organic value (OV) and an inorganic value (IV) are obtained by adding the score thereof. These values are plotted on a diagram in which the organic value is represented on the X-axis and the inorganic value is represented on the Y-axis. IOB in the organic conceptual diagram refers to a ratio of the inorganic value (IV) to the organic value (OV) in the organic conceptual diagram, that is, “inorganic value (IV)/organic value (OV)”. The details of the organic conceptual diagram can be referred to “New Edition Organic Conceptual Diagram—Foundation and Application—” (written by Yoshio KOUDA, Sankyo Shuppan Co., Ltd., 2008). In the present specification, the hydrophilic and hydrophobic properties are represented by a “1/IOB” value which was obtained by taking a reciprocal number of JOB. This is a notation of representing more hydrophilic properties as the “1/IOB” value becomes small (close to 0).

The hydrophilic properties and water absorbency are increased by causing the “1/IOB” value of the polypeptide used in the present invention to be within the above-described range.

With respect to the polypeptide used in the present invention, the hydrophilic and hydrophobic indexes represented by a grand average of hydropathicity (GRAVY) value are preferably −9.0 to 0.3, and more preferably −7.0 to 0.0. The grand average of hydropathicity (GRAVY) value can be obtained by methods of “Gasteiger E., Hoogland C., Gattiker A., Duvaud S., Wilkins M. R., Appel R. D., Bairoch A.; Protein Identification and Analysis Tools on the ExPASy Server; (In) John M. Walker (ed): The Proteomics Protocols Handbook, Humana Press (2005). pp. 571 to 607” and “Gasteiger E., Gattiker A., Hoogland C., Ivanyi I., Appel R. D., Bairoch A.; ExPASy: the proteomics server for in-depth protein knowledge and analysis; Nucleic Acids Res. 31:3784 to 3788 (2003)”.

The hydrophilic properties and water absorbency become high by making the GRAVY value of the polypeptide used in the present invention be within the above-described range.

[Recombinant Gelatin]

The polypeptide used in the present invention is preferably recombinant gelatin.

Examples thereof include recombinant gelatin disclosed in EP1014176, U.S. Pat. No. 6,992,172B, WO2004/85473A, and WO2008/103041A, but the recombinant gelatin is not limited thereto. Preferred recombinant gelatin used in the present invention is recombinant gelatin of the following aspect.

The recombinant gelatin is excellent in biocompatibility with original performance of natural gelatin, and is excellent in non-infection properties since there is no concern of bovine spongiform encephalopathy (BSE) and the recombinant gelatin with not being naturally derived.

The molecular weight of recombinant gelatin is not particularly limited, but is preferably 2,000 to 100,000 (2 kDa (kilodaltons) to 100 kDa), more preferably (2,500 to 95,000 (2.5 kDa to 95 kDa), even more preferably 5,000 to 90,000 (5 kDa to 90 kDa), and most preferably 10,000 to 90,000 (10 kDa to 90 kDa).

The recombinant gelatin preferably has a repetition of a sequence represented by Gly-X-Y which is characteristic to collagen. Here, a plurality of pieces of Gly-X-Y may be identical to or different from each other. In Gly-X-Y, Gly represents glycine and X and Y represent any amino acid (preferably represents any amino acid other than glycine). The sequence represented by Gly-X-Y characteristic to collagen is a partial structure which is extremely specific compared to other protein in a composition or a sequence of an amino acid of gelatin/collagen. In this section, glycine occupies about one third of the entirety of the amino acid sequence, one sequence is repeated every three sequences. Glycine is the simplest amino acid. Therefore, there is a little restraint in arrangement of molecular chains and glycine significantly contributes to regeneration of a helix structure during gelation. It is preferable that amino acids represented by X and Y contain many imino acids (proline and oxyproline) and occupy 10% to 45% of the entirety of the sequence. Preferably 80% or more of the sequence of the amino acids, more preferably 95% or more of the sequence of the amino acids, and most preferably 99% or more of the sequence of the amino acids in the recombinant gelatin have a repeating structure of Gly-X-Y.

In general gelatin, a polar amino acid with an electrical charge and a polar non-charged amino acid exist by 1:1 in polar amino acids. Here, the polar amino acid specifically indicates cysteine, aspartic acid, glutamic acid, histidine, lysine, asparagine, glutamine, serine, threonine, tyrosine, or arginine. Among these, the polar non-charged amino acid indicates cysteine, asparagine, glutamine, serine, threonine, or tyrosine. In recombinant gelatin used in the present invention, the proportion of the polar amino acid in the whole constituent amino acid is 10% to 40% and preferably 20% to 30%. The proportion of a non-charged amino acid in the polar amino acid is preferably greater than or equal to 5% and less than 20% and more preferably greater than or equal to 5% and less than 10%. It is preferable that any one amino acid or preferably two or more amino acids among serine, threonine, asparagine, tyrosine, and cysteine are not contained on a sequence.

In general, in polypeptides, minimum amino acid sequences which work as cell adhesion signals are known (for example, Nagai Shoten Co., Ltd., “Pathophysiology”, Vol. 9, No. 7 (1990) p. 527). The recombinant gelatin used in the present invention preferably has two or more of these cell adhesion signals in one molecule. As the specific sequences, sequences such as an RGD sequence, an LDV sequence, an REDV sequence (SEQ ID NO: 2), a YIGSR sequence (SEQ ID NO: 3), a PDSGR sequence (SEQ ID NO: 4), an RYVVLPR sequence (SEQ ID NO: 5), an LGTIPG sequence (SEQ ID NO: 6), an RNIAEIIKDI sequence (SEQ ID NO: 7), an IKVAV sequence (SEQ ID NO: 8), an LRE sequence, a DGEA sequence (SEQ ID NO: 9), and an HAV sequence, which are represented by one-letter notation of amino acids are preferable in that there are many kinds of cells adhered. An RGD sequence, a YIGSR sequence (SEQ ID NO: 3), a PDSGR sequence (SEQ ID NO: 4), an LGTIPG sequence (SEQ ID NO: 6), an IKVAV sequence (SEQ ID NO: 8), and a HAV sequence are more preferable and an RGD sequence is particularly preferable. In the RGD sequence, an ERGD (SEQ ID NO: 10) sequence is preferable.

As arrangement of RGD sequences in recombinant gelatin used in the present invention, it is preferable that the number of amino acids between RGDs is between 0 to 100 and preferably between 25 to 60 without being even.

The content of this minimum amino acid sequence is preferably 3 to 50, more preferably 4 to 30, and particularly preferably 5 to 20 in one molecule of protein. The most preferable content thereof is 12.

In recombinant gelatin used in the present invention, the proportion of RGD motifs with respect to the total number of amino acids is preferably at least 0.4%. In a case where recombinant gelatin contains 350 or more amino acids, each stretch of the 350 amino acids preferably contains at least one RGD motif. The proportion of RGD motifs is more preferably at least 0.6%, even more preferably at least 0.8%, still even more preferably at least 1.0%, particularly preferably at least 1.2%, and most preferably at least 1.5% with respect to the total number of amino acids. The number of RGD motifs within a recombinant peptide is preferably at least 4, more preferably 6, even more preferably 8, and particularly preferably 12 to 16 per 250 amino acids. The proportion of RGD motifs being 0.4% corresponds to at least one RGD sequence per 250 amino acids. The number of RGD motifs is an integer, and therefore, gelatin formed of 251 amino acids needs to contain at least two RGD sequences in order to satisfy the characteristics of 0.4%. It is preferable that the recombinant gelatin of the present invention contains at least two RGD sequences per 250 amino acids, more preferably contains at least three RGD sequences per 250 amino acids, and even more preferably contains at least four RGD sequences per 250 amino acids. As a further mode of the recombinant gelatin of the present invention, the recombinant gelatin contains at least 4 RGD motifs, preferably 6 RGD motifs, more preferably 8 RGD motifs, and even more preferably 12 to 16 RGD motifs.

In addition, the recombinant gelatin may be partially hydrolyzed.

The polypeptide used in the present invention is more preferably represented by Formula 2.

Gly-Ala-Pro-[(Gly-X-Y)₆₃]₃-Gly (SEQ ID NO: 11) Formula (2):

in the formula, 63 pieces of X (=Xaa) each independently represent any amino acid and 63 pieces of Y (=Xaa) each independently represent any amino acid, and 63 pieces of Gly-X-Y may be identical to or different from each other.

It is preferable that a plurality of sequence units of collagen which naturally exists are bonded to a repeating unit. Any naturally existing collagen referred to herein may be used as long as the collagen naturally exists, but is preferably I type collagen, II type collagen, III type collagen, IV type collagen, or V type collagen, and more preferably I type collagen, II type collagen, or III type collagen. According to another form, the above-described collagen is preferably derived from a human-type, cattle, a pig, a mouse, or a rat, and is more preferably derived from a human-type.

An isoelectric point of the recombinant gelatin used in the present invention is preferably 5 to 10, more preferably 6 to 10, and even more preferably 7 to 9.5. The measurement of the isoelectric point of the recombinant gelatin can be carried out by measuring the pH after passing a 1 mass % gelatin solution through a mixed crystal column of a cation-anion exchange resin above-described disclosed in isoelectric focusing method (refer to Maxey, C. R. (1976; Phitogr. Gelatin 2, Editor Cox, P. J. Academic, London, Engl.)).

It is preferable that the recombinant gelatin is not deaminated.

It is preferable that the recombinant gelatin does not have a telopeptide.

It is preferable that the recombinant gelatin is a substantially pure polypeptide which is prepared using a nucleic acid encoding an amino acid sequence.

The recombinant gelatin is particularly preferably
(1) an amino acid sequence described in SEQ ID No: 1; or
(2) an amino acid sequence having 80% or more (preferably 90% or more, more preferably 95% or more, and particularly preferably 98% or more) sequence identity to the amino acid sequence described in SEQ ID No: 1 and has biocompatibility.

Biocompatibility means that, in a case of being brought into contact with a living body, it does not give a rise to a remarkable adverse reaction such as long-term and chronic inflammatory reaction.

The recombinant gelatin most preferably has the amino acid sequence described in SEQ ID No: 1.

The sequence identity of the embodiment of the present invention refers to a value calculated in the following equation.

% Sequence identity=[(the number of identical residues)/(alignment length)]×100

The sequence identity between two amino acid sequences can be determined by any method well-known to those skilled in the art and can be determined by the Basic Local Alignment Search Tool (BLAST) program (J. Mol. Biol. 215: 403 to 410, 1990) or the like.

The recombinant gelatin is formed of an amino acid sequence in which one or several amino acids are deleted, substituted, or added in the amino acid sequence described in SEQ ID No: 1 and has biocompatibility.

“One or several” in the expression “amino acid sequence in which one or several amino acids are deleted, substituted, or added” preferably means 1 to 20 amino acids, more preferably means 1 to 10 amino acids, even more preferably means 1 to 5 amino acids, and particularly preferably means 1 to 3 amino acids.

The recombinant gelatin can be manufactured through gene recombination technology which is known to those skilled in the art, and can be manufactured in accordance with, for example, methods disclosed in EP1014176A2, U.S. Pat. No. 6,992,172B, WO2004/85473A, and WO2008/103041A. Specifically, a gene encoding an amino acid sequence of predetermined recombinant gelatin is acquired, the acquired gene is incorporated into an expression vector to manufacture a recombinant expression vector, and a transformant is manufactured by introducing the recombinant expression vector into an appropriate host. The recombinant gelatin is produced by culturing the obtained transformant in an appropriate medium. Therefore, it is possible to prepare the recombinant gelatin used in the present invention by collecting the recombinant gelatin produced from a culture product.

[Form of Cell Mass or Cell Structure-Embedding Agent]

The cell mass or cell structure-embedding agent according to the embodiment of the present invention is not particularly limited, and can have any forms, as long as the cell mass or cell structure-embedding agent includes polypeptide that is represented by Formula 1 and of which the molecular weight distribution satisfies Condition X. For example, the form may be a solution (such as an aqueous solution), a suspension, a powder, or a gel. In the case of powder or gel, the cell mass or cell structure-embedding agent can be used by dissolving in a solvent such as water in a case use.

The content of the polypeptide in the cell mass or cell structure-embedding agent according to the embodiment of the present invention is not particularly limited, and is generally 0.1 mass % to 100 mass % and preferably 0.5 mass % to 100 mass %.

The cell mass or the cell structure to which the cell mass or cell structure-embedding agent according to the embodiment of the present invention is applied is described below in the present specification.

<Cell Mass or Cell Structure-Containing Composition>

The present invention relates to a cell mass or cell structure-containing composition including a cell mass or a cell structure, and the cell mass or cell structure-embedding agent according to the embodiment of the present invention, and the cell mass or the cell structure is embedded by the cell mass or the cell structure-embedding agent.

[Cell Mass]

The cell mass of the present invention is in a state in which a plurality of cells are associated into one mass and is a cell mass a diameter of one mass is 100 μm or more, and a value of a major axis/a minor axis of one mass is 200 or less.

The cells may be linked to each other directly and/or via an inclusion. The inclusion is not particularly limited as long as the inclusion is a material capable of at least mechanically linking cells, and examples thereof include an extracellular matrix. The inclusion is preferably a cell-derived material, particularly, a material derived from a cell constituting a cell mass or a cell structure. The cells are at least mechanically linked, but may be further functionally, for example, chemically and electrically linked to each other.

The cell mass can be produced by a well-known cell mass manufacturing method or an equivalent method thereto. For example, cells may be cultured in a U-shaped bottom plate or a multiwell dish, and after the cells are aggregated, the mass may be recovered from the culture dish. As another method, cell clumps can be manufactured by self-aggregation of cells by stirring the cells. As described above, the method for manufacturing a cell mass is not particularly limited, but as an example, a cell mass or a cell structure can be manufactured by a method disclosed in JP1993-268933A (JP-H05-268933A).

A cell mass is typically manufactured by a step of seeding cells in a culture dish and a step of culturing the cells to form a cell mass. As another method, a cell mass is manufactured by a step of culturing the cells with stirring.

The cells can be cultured under conditions commonly used in the art. For example, typical culture conditions include culturing a cell at 37° C. in 5% CO₂.

[Cell Structure]

A cell structure in the present invention means that cells and cell supports are in contact with each other or are adhered to each other to have a three-dimensional form.

As the cell structure, a cell structure that includes a biocompatible macromolecular block and a cell and in which the plurality of biocompatible macromolecular blocks are disposed in gaps between the plurality of cells is preferable.

[Biocompatible Macromolecular Block]

(1) Biocompatible Macromolecule

Biocompatibility means that, in a case of being brought into contact with a living body, it does not give a rise to a remarkable adverse reaction such as long-term and chronic inflammatory reaction. Whether or not the biocompatible macromolecules used in the present invention are decomposed within a living body is not particularly limited as long as the biocompatible macromolecules have affinity to the living body. However, biodegradable macromolecules are preferable. Specific examples of non-biodegradable materials include polytetrafluoroethylene (PTFE), polyurethane, polypropylene, polyester, vinyl chloride, polycarbonate, acryl, stainless steel, titanium, silicone, and 2-methacryloyloxyethyl phosphorylcholine (MPC). Specific examples of the biodegradable materials include naturally derived peptides, polypeptides such as a recombinant peptide or a chemically synthesized peptide, polylactic acid, polyglycolic acid, lactic acid-glycolic acid copolymers (PLGA), hyaluronic acid, glycosaminoglycan, proteoglycan, chondroitin, cellulose, agarose, carboxymethyl cellulose, chitin, and chitosan. Among the above, polypeptide is particularly preferable. Devising of an improvement of cell adhesion properties in these biocompatible macromolecules may be performed. Specifically, methods of “coating with the cell adhering substrate (fibronectin, vitronectin, laminin) and the cell adhesion sequence (RGD sequence, LDV sequence, REDV sequence, YIGSR sequence, PDSGR sequence, RYVVLPR sequence, LGTIPG sequence, RNIAEIIKDI sequence, IKVAV sequence, LRE sequence, DGEA sequence, and HAV sequence) peptide”, “amination and cationization of the substrate surface”, or “plasma treatment of the substrate surface” can be used.

Polypeptide suitable as a biocompatibility polymer is the same as the polypeptide represented by Formula 1, which is used in the present invention.

(2) Cross-Linking

The biocompatible macromolecules may be or may not be cross-linked, but are preferably cross-linked. By using the cross-linked biocompatible macromolecules, it is possible to obtain an effect of preventing instant decomposition during culturing in a medium and during transplantation into a living body. As general cross-linking methods, thermal cross-linking, cross-linking using aldehydes (for example, formaldehyde or glutaraldehyde), cross-linking using a condensation agent (carbodiimide, cyanamide, or the like), enzymatic cross-linking, photocrosslinking, ultraviolet cross-linking, a hydrophobic interaction, hydrogen bonding, an ionic interaction, and the like are known, it is also possible to use the above-described cross-linking methods of the embodiment of the present invention. As the cross-linking methods used in the present invention, thermal cross-linking, ultraviolet cross-linking, or enzymatic cross-linking is more preferable, and thermal cross-linking is particularly preferable.

In a case of performing cross-linking using an enzyme, there is no particular limitation as long as the enzyme has a cross-linking action between macromolecular materials. However, it is possible to perform cross-linking preferably using transglutaminase and laccase and most preferably using transglutaminase. Specific examples of protein to be subjected to enzymatic cross-linking using transglutaminase are not particularly limited as long as the protein has a lysine residue and a glutamine residue. Transglutaminase may be derived from a mammal or may be derived from a microorganism. Specific examples thereof include mammal derived transglutaminase which has been sold as Activa series manufactured by Ajinomoto Co., Inc., and a reagent; guinea pig liver derived transglutaminase manufactured by, for example, Oriental Yeast Co., Ltd., Upstate USA Inc., or Biodesign International, Inc.; goat derived transglutaminase; rabbit derived transglutaminase; and human derived blood coagulation factors (Factor XIIIa: Haematologic Technologies, Inc).

The reaction temperature in a case of performing cross-linking (for example, thermal cross-linking) is not particularly limited as long as cross-linking can be performed, but is preferably −100° C. to 500° C., more preferably 0° C. to 300° C., even more preferably 50° C. to 300° C., particularly preferably 100° C. to 250° C., and most preferably 120° C. to 200° C.

(3) Biocompatible Macromolecular Block

The shape of the biocompatible macromolecular block is not particularly limited. Examples thereof include an amorphous shape, a spherical shape, a particulate shape (granule), a powdery shape, a porous shape, a fibrous shape, a spindle shape, a flat shape, and a sheet shape. An amorphous shape, a spherical shape, a particulate shape (granule), a powdery shape, and a porous shape are preferable. The amorphous shape indicates that the shape of a surface is uneven, and indicates, for example, an object, such as rock, which has roughness. Examples of the above-described shapes are not distinct from each other. For example, in some cases, an example of a subordinate concept of the particulate shape (granule) is an amorphous shape.

The size of one biocompatible macromolecular block is preferably 1 μm to 700 μm, more preferably 10 μm to 700 μm, even more preferably 10 μm to 300 μm, and still even more preferably 20 μm to 150 μm.

The method for producing a biocompatible macromolecular block is not particularly limited. For example, it is possible to obtain a biocompatible macromolecular block by pulverizing a solid matter (such as a porous body of a biocompatible macromolecule) containing a biocompatible macromolecule using a pulverizer (such as NEW POWERMILL). The solid matter (such as a porous body of a biocompatible macromolecule) containing a biocompatible macromolecule can be obtained, for example, by freeze-drying an aqueous solution containing the biocompatible macromolecule.

[Cell]

The cell mass or cell structure or the cell structure according to the embodiment of the present invention includes any cells that can form a cell mass or cell structure or a cell structure. Cells to be used are preferably animal cells, more preferably vertebrate derived cells, and particularly preferably human derived cells. The types of vertebrate derived cells (particularly, human-type derived cells) may be any of universal cells, somatic stem cells, precursor cells, and mature cells and particularly preferably somatic stem cells.

It is possible to use, for example, embryonic stem (ES) cells, germ-stem (GS) cells, or artificial pluripotent stem (iPS) cells as the universal cells. It is possible to use, for example, mesenchymal stem cells (MSC), hematopoietic stem cells, amniotic cells, umbilical cord blood cells, bone marrow derived cells (for example, bone marrow derived MSCs), myocardial stem cells, adipose derived stem cells, or neural stem cells can be used as the somatic stem cell. It is possible to use, for example, skin, dermis, epidermis, muscle, cardiac muscles, nerves, bones, cartilage, endothelium, brain, epithelium, heart, kidney, liver, pancreas, spleen, oral cavity, cornea, bone marrow, umbilical cord blood, amnion, or cells derived from hair as the precursor cells and the mature cells. It is possible to use, for example, ES cells, iPS cells, MSCs, chondrocytes, osteoblasts, osteoprecursor cells, mesenchymal cells, myoblasts, cardiac muscle cells, cardiomyoblasts, nerve cells, hepatocytes, beta cells, fibroblasts, corneal endothelial cells, vascular endothelial cells, corneal epithelial cells, amniotic cells, umbilical cord blood cells, bone marrow-derived cells, or hematopoietic stem cells as the human-type-derived cells. In addition, the cells may be derived from any of autologous cells and heterologous cells.

[Cell Structure]

The cell structure in the present invention is a cell structure in which the plurality of macromolecular blocks having biocompatibility and the cell are used, and the plurality of macromolecular blocks are three-dimensionally arranged in gaps between a plurality of cells in a mosaic shape.

The thickness or the diameter of the cell structure can be caused to be a desired thickness, but the lower limit is preferably 150 μm or more, more preferably 215 μm or more, and most preferably 400 μm or more. The upper limit of the thickness or the diameter is not particularly limited, but the general range in use is preferably 3 cm or less, more preferably 2 cm or less, and even more preferably 1 cm or less.

The cell structure can be manufactured by alternately arranging biocompatible macromolecular blocks and cells. The manufacturing method is not particularly limited, but is preferably a method of seeding cells after a biocompatible macromolecular block is formed. Specifically, cell structures can be manufactured by incubating a mixture of the biocompatible macromolecular blocks and a cell-containing culture solution. For example, the cells and the macromolecular blocks having biocompatibility manufactured in advance are arranged in a mosaic shape in a container or in a solution held in a container. As means of disposition, it is preferable to promote and control mosaic-like disposition consisting of the cells and the biocompatible substrate by using natural aggregation, natural falling, centrifugation, and stirring.

The container to be used is preferably a container consisting of a cell low adhesive material or a cell non-adhesive material and more preferably a container consisting of polystyrene, polypropylene, polyethylene, glass, polycarbonate, and polyethylene terephthalate. The shape of the bottom surface of the container is preferably a flat bottom shape, a U shape, or a V shape. As the container, a multiwell-type container may be used.

[Manufacturing of Cell Mass or Cell Structure-Containing Composition]

A cell mass or cell structure-containing composition can be manufactured by embedding the cell mass or cell structure by the cell mass or cell structure-embedding agent according to the embodiment of the present invention. The embedding method is not particularly limited, but the embedding agent (preferably solution) of the present invention may be added to a container including a cell mass or a cell structure and cooled at a low temperature (for example, 2° C. to 12° C.) to gell the solution. According to the above, it is possible to manufacture a cell mass or cell structure-containing composition in which a cell mass or cell structure is embedded with a cell mass or cell structure-embedding agent.

<Kit>

According to the present invention, there is provided a kit including the cell mass or cell structure and the cell mass or cell structure-embedding agent according to the embodiment of the present invention. Details and preferable aspects of the cell mass or cell structure and the cell mass or cell structure-embedding agent are as described above in the present specification. The kit may further include a container for performing an embedding treatment, an instruction manual, and the like.

The present invention will be more specifically described using the following examples, but is not limited by the examples.

### EXAMPLES

(1) Recombinant Gelatin

The following CBE3 (which is disclosed in WO2008/103041A) was prepared as recombinant gelatin.

CBE3:

Molecular weight: 51.6 kD

Structure: GAP[(GXY)₆₃]₃G (SEQ ID NO: 11)

Number of amino acids: 571

RGD sequence: 12

Imino acid content: 33%

Almost 100% of amino acids have a repeating structure of GXY. In the amino acid sequence of CBE3, serine, threonine, asparagine, tyrosine, and cysteine are not included. CBE3 has an ERGD sequence (SEQ ID NO: 10).

Isoelectric point: 9.34

GRAVY value: −0.682

1/IOB value: 0.323

Amino acid sequence (SEQ ID No: 1 in a sequence table) (which is the same as that of SEQ ID No: 3 in WO2008/103041A. However, X in the end is corrected to “P”).

GAP(GAPGLQGAPGLQGMPGERGAAGLPGPKGERGDAGPKGADGAPGAPGL QGMPGERGAAGLPGPKGERGDAGPKGADGAPGKDGVRGLAGPIGPPGERGAAGLPG PKGERGDAGPKGADGAPGKDGVRGLAGPIGPPGPAGAPGAPGLQGMPGERGAAGLP GPKGERGDAGPKGADGAPGKDGVRGLAGPP)3G

(2) Measurement of Molecular Weight Distribution of Recombinant Gelatin

With respect to the recombinant gelatin CBE3 (Example 1) described in (1), molecular weight distribution was measured by using gel permeation chromatography (GPC). In the measurement of the molecular weight distribution, HPLC (AQUITY UPLC system Empower 2 manufactured by Waters Corporation) was used, and 100 mmol/L of a phosphate buffer (pH 6.8) was used as a buffer solution. Relativity of the molecular weight distribution of recombinant gelatin was measured by using these.

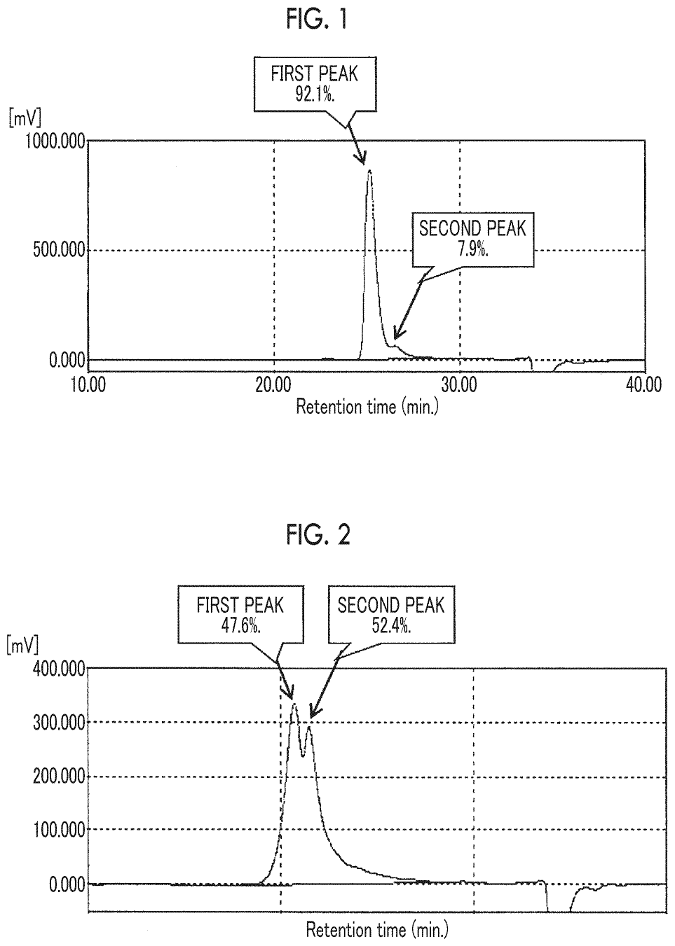

The results thereof are provided in FIG. 1. Two molecular weight peaks of CBE3 were present. In a case where occupancies of the peaks in all the peaks were calculated from the area ratio for these two peaks, the occupancy that of the first peak was 92.1% and the occupancy of the second peak was 7.9%. From this, it was found that CBE3 had a molecular weight peak that occupies 92% as a high occupancy peak.

(3) Measurement of Molecular Weight Distribution of Natural Animal Gelatin

In comparison, for natural animal gelatin (Comparative Example 1), the molecular weight distribution was measured by using GPC in the same manner as in (2) above. The results are provided in FIG. 2. Two molecular weight peaks of the natural animal gelatin were present. In a case where occupancies of the peaks in all the peaks were calculated from the area ratio for these two peaks, the occupancy that of the first peak was 47.6%, and the occupancy of the second peak was 52.4%. From this, it was found that the natural animal gelatin had a molecular weight peak that occupies 52% as a high occupancy peak.

(4) Embedding Agent Performance Test (Gelation Rate)

In order to use as an embedding agent in a case of transporting a cell mass or a cell structure, the performance in which the gelation rate at low temperature is fast, and conversely, the embedding agent quickly returns to liquid at room temperature, as a reversible reaction becomes important. Therefore, the gelation rate at low temperature and the speed of returning to the liquid at room temperature were tested at a concentration of 1 mass %.

As a result, it was observed that CBE3 of Example 1 was rapidly gelled by returning to 4° C., and the fluidity of the liquid rapidly decreased, and in a case where the completely gelled sample was transferred to a room temperature environment of 25° C., CBE3 quickly returns to the liquid.

Specifically, in CBE3, gelation started after 40 minutes from returning to 4° C., and almost stable gel was obtained after 50 minutes. The gel was a strong gel which was not crushed even in a case of being pressed by hand. The gel returned to room temperature at 25° C. and returned to a complete liquid in 40 minutes.

Meanwhile, the natural animal gelatin of Comparative Example 1 was gelled by returning to 4° C., but the speed thereof was gradual and slower than that of CBE3. As a result of transferring the completely gelled sample to a room temperature environment of 25° C. and testing the speed of returning to the liquid again, in the natural animal gelatin of Comparative Example 1, the speed of returning to liquid was slower than that in CBE3 of Example 1.

Specifically, in the natural animal gelatin, the gelation started after 60 minutes by transferring to 4° C., but only a loose gel was obtained even after 90 minutes. After that, the natural animal gelatin did not transfer to a strong gel, and remained in a loose gel state that was able to be easily crushed by hand pressing. In a case where the gell-state material was returned to room temperature of 25° C., it took 70 minutes for the natural animal gelatin to return to a complete liquid.

(5) Manufacturing of CBE3 Embedded Cell Mass or CBE3 Embedded Cell Structure

Human bone marrow-derived mesenchymal stem cells (hMSCs) were suspended in a proliferation medium (Takara Bio Inc.: MSCGM Bullet Kit (trademark)), biocompatible macromolecular blocks (53 to 106 μm) as in WO2015046216A1 were added thereto, in a state in which hMSCs (1.2×10⁶ cells) and biocompatible macromolecular blocks (1 mg) were finally suspended in 4 mL of a medium, the mixture was sown in EZSPHERE (registered trademark) DISH Type 903 (which had a spheroid well diameter of 800 μm, a spheroid well depth of 300 μm, and about 1,000 spheroid wells, in which bottom surface was a culture surface having a recess portion, and has a side outer wall erected on the periphery of the culture surface, and which was manufactured by AGC TECHNO GLASS CO., Ltd.) which was a cell non-adhesive 35 mm dish. After culturing for 69 hours, about 1,000 cell structures were obtained. A cell mass was also able to be obtained by carrying out the same operation without adding a biocompatible macromolecular block.

The obtained cell structures or cell masses were separated into several cell structures or cell masses in 96 well plates, 200 uL of HBSS+(manufactured by Thermo Fisher Scientific) including 1 mass % of CBE3 was added, and cooling was performed at 2° C. to 8° C. for one hour for gelation, so as to manufacture a CBE3 embedded cell mass or a CBE3 embedded cell structure. HBSS is an abbreviation of Hanks' Balanced Salt solution.

(6) Vibration Evaluation

(6-1)

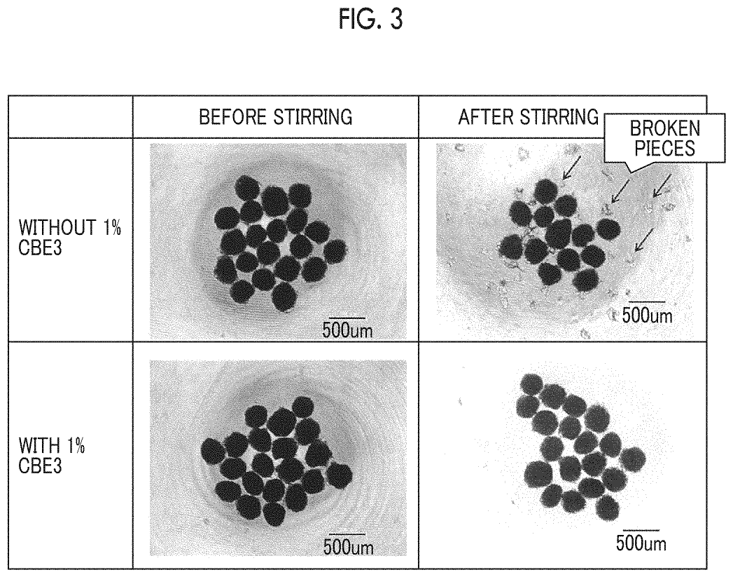

The CBE3 embedded cell mass or the CBE3 embedded cell structure manufactured in (5) above was placed on a MicroPlateMixer (NS-P, manufactured by As One Corporation), and was shaken at 2° C. to 8° C. for two days with the maximum number of shaking set. As a control, HBSS+ without CBE3 was added to the cell mass or cell structure, and shaken in the same manner. After the shaking, the CBE3 embedded cell mass or the CBE3 embedded cell structure was left at room temperature, and the gel was thawed to recover the cell mass or cell structure. The shape of the cell structure before and after the shaking is shown in FIG. 3.

In a case where HBSS+ without CBE3 was added, the cell mass or cell structure after the shaking was broken, but, in a case where the cell mass or cell structure was embedded with HBSS+ including 1 mass % of CBE3, the cell mass or cell structure was not broken even after the shaking.

(6-2)

In a case where HBSS+ including 1 mass % of CBE3 was added, the cell mass or cell structure recovered after shaking was cultured, so as to check that the cell mass or cell structures were fused with each other. This indicates that the cells in the cell mass or cell structure are alive, and it was checked that the cell mass or cell structure can sufficiently exhibit the performance thereof.

[SEQUENCE LISTING] International Application 17F02612 cell mass or cell structure embedding agent JP18007943 20180302----00030043851800434061 Normal 20180302105902201802141715595530_P1AP101_17_0.app based on the International Patent Cooperation Treaty

What is claimed is:

1. A cell mass or cell structure-embedding agent comprising: polypeptide which is represented by Formula 1 and in which a molecular weight distribution satisfies Condition X,
A-[(Gly-X-Y)ₙ]ₘ-B Formula (1):
in the formula, n X's each independently represent any amino acid, n Y's each independently represent any amino acid, m is an integer of 2 to 10, n is an integer of 3 to 100, A represents any amino acid or amino acid sequence, and B represents any amino acid or amino acid sequence,
Condition X: An area of the maximum molecular weight peak in molecular weight distribution measurement by gel permeation chromatography is 80% or more of the total area of all of the molecular weight peaks.

2. The cell mass or cell structure-embedding agent according to claim 1,
wherein the polypeptide is recombinant gelatin.

3. The cell mass or cell structure-embedding agent according to claim 1, wherein the molecular weight of recombinant gelatin is 10 kDa to 90 kDa.

4. The cell mass or cell structure-embedding agent according to claim 1,
wherein the polypeptide is polypeptide represented by Formula 2,
Gly-Ala-Pro-[(Gly-X-Y)₆₃]₃-Gly Formula 2:
in the formula, 63 pieces of X each independently represent any amino acid and 63 pieces of Y each independently represent any amino acid, and 63 pieces of Gly-X-Y may be identical to or different from each other.

5. The cell mass or cell structure-embedding agent according to claim 1,
wherein the polypeptide has (1) an amino acid sequence presented in SEQ ID NO: 1 or (2) an amino acid sequence that has 80% or more of sequence identity with the amino acid sequence presented in SEQ ID NO: 1 and has biocompatibility.

6. The cell mass or cell structure-embedding agent according to claim 1,
wherein the polypeptide has an amino acid sequence presented in SEQ ID NO: 1.

7. A cell mass or cell structure-containing composition comprising:
a cell mass or cell structure; and
the cell mass or cell structure-embedding agent according to claim 1,
wherein the cell mass or the cell structure is embedded with the cell mass or cell structure-embedding agent.

8. A kit comprising:
a cell mass or cell structure; and
the cell mass or cell structure-embedding agent according to claim 1.

9. A method for transporting a mass or cell structure, which comprise immersing the mass or cell structure in the cell mass or cell structure-embedding agent according to claim 1.

10. The method according to claim 9, wherein the polypeptide is a recombinant gelatin.

11. The method according to claim 10, wherein the molecular weight of recombinant gelatin is 10 kDa to 90 kDa.

12. The method according to claim 9, wherein the polypeptide has (1) amino acid sequence of SEQ ID NO: 1 or (2) amino acid sequence which has a sequence identity of 80% or more with the amino acid sequence of SEQ ID NO: 1 and has biocompatibility.

13. The method according to claim 9, wherein the polypeptide has the amino acid sequence of SEQ ID NO: 1.

14. The method according to claim 9, wherein the polypeptide is gel at the time of transport.

15. The method according to claim 9, which comprises immersing the cell sheet in a polypeptide in solution state at 25° C. or higher, transporting the cell sheet wherein the polypeptide in gel state at 4° C. or lower, and returning the polypeptide to a solution at 25° C. or higher.

16. The method according to claim 9, wherein the polypeptide is a recombinant gelatin, and which comprises immersing the cell sheet in a polypeptide in solution state at 25° C. or higher, transporting the cell sheet wherein the polypeptide in gel state at 4° C. or lower, and returning the polypeptide to a solution at 25° C. or higher.
